(19) United States
(12) Patent Application Publication
(10) Pub. No.: US 2026/0001752 A1
(43) Pub. Date: Jan. 1, 2026

(54) HIGH-ELEVATION WORK VEHICLE

(71) Applicant: JB SOLUTION CO., LTD., Sejong (KR)

(72) Inventor: Sang Moon PARK, Sejong (KR)

(21) Appl. No.: 19/322,338

(22) Filed: Sep. 8, 2025

Related U.S. Application Data
(63) Continuation of application No. PCT/KR2024/009727, filed on Jul. 9, 2024.

(30) Foreign Application Priority Data
Jul. 25, 2023 (KR) 10-2023-0096929

(51) Int. Cl. B66F 11/04

(52) U.S. Cl. CPC B66F 11/046

(57) ABSTRACT

Proposed is a high-elevation work vehicle used for work performed at high elevations. The high-elevation work vehicle may include a vehicle having a stage and a high-elevation work assembly installed on the stage. The high-elevation work assembly may include a bucket that an operator can board, and a boom module for moving the bucket in a three-dimensional space to a work area. The boom module may include a multi-stage boom that has the bucket installed at one end and that moves the bucket in a three-dimensional space to a work area while expanding and contracting. The boom module may be obliquely positioned with respect to the centerline of the vehicle parallel to the longitudinal direction of the vehicle when positioned on the stage in a state in which the multi-stage boom is contracted.

### CROSS-REFERENCE TO RELATED APPLICATIONS

This is a continuation application of International Application No. PCT/KR2024/009727 filed on Jul. 9, 2024, which claims under 35 U.S.C. § 119(e) the benefit of Korean Patent Application No. 10-2023-0096929 filed on Jul. 25, 2023, the entire content of each of which is incorporated by reference herein.

### BACKGROUND

### Technical Field

The present disclosure relates to an aerial work vehicle and, more particularly, to an aerial work vehicle suitable for use in a work performed at a high elevation.

### Description of Related Technology

An aerial work vehicle is used for tasks such as construction, inspection, and maintenance performed at high elevations. For example, the aerial work vehicle may be used for an electric cable construction, a signboard installation, a street tree trimming, and a streetlight work, but also for specialized operations such as a live-line maintenance of high-voltage distribution lines, an electricity service line installation, a hydraulic tool operation, and a pole-mounted transformer installation.

### SUMMARY

One aspect is an aerial work vehicle enabling stable installation of an aerial work assembly while satisfying design constraints that may be critical because of a stage of limited dimensions.

Another aspect is an aerial work vehicle having a physically robust bucket.

Another aspect is an aerial work vehicle minimizing losses in lengths of boom segments that may be caused by rollers installed at distal ends of the boom segments.

Another aspect is an aerial work vehicle having a multi-stage boom exhibiting a superior mechanical durability against stresses such as torsion and bending.

Another aspect is an aerial work vehicle including: a vehicle comprising a stage; and an aerial work assembly installed on the stage.

The aerial work assembly includes: a bucket in which an operator can board; and a boom module comprising a multi-stage boom having an end at which the bucket is installed and capable of being expanded and retracted to move the bucket in a three-dimensional space to a work area and configured to be positioned obliquely with respect to a center line of the vehicle parallel to a longitudinal direction of the vehicle when the multi-stage boom is retracted and parked on the stage.

The boom module includes: a drive table installed on the stage and capable of rotating horizontally; a rotating frame installed on the drive table and having a polygonal prism shape with an internal hollow; and the multi-stage boom coupled to the rotating frame.

The bucket may be installed on a lateral surface of a foremost boom segment of the multi-stage boom. The lateral surface may correspond to a surface facing a relatively wider space of the stage in a viewpoint from the multi-stage boom positioned obliquely when the multi-stage boom is retracted and parked on the stage.

The bucket may have a box shape with a trapezoidal cross section and may be installed such that a surface based on a longer edge of two parallel edges of a trapezoid may face the lateral surface of the foremost boom segment

The foremost boom segment and the bucket may be made of an insulating material.

The multi-stage boom may include a plurality of boom segments expandable and retractable telescopically by rollers and wires.

When the multi-stage boom is retracted with the plurality of boom segments nested, the rollers installed at the distal ends of the plurality of boom segments may be gathered at a location.

Each of the plurality of boom segments on which the rollers are installed may be provided with a roller case mounted at the distal end of the boom segment to protect the roller,

The roller cases of boom segments preceding a rearmost roller case may be sequentially inserted and nested in the rearmost roller case.

The roller case may include a roller accommodating portion configured to receive the roller and a stopper coupled to the roller accommodating portion.

The stopper may be located closer to an entrance opening of a corresponding boom segment than the roller accommodating portion. When the boom segments are being retracted and nested, the roller accommodating portions of the roller cases may be nested and the stoppers are sequentially stacked and protrude outward.

Each of the boom segments may have a tubular structure with a polygonal cross-section of more than six sides.

The boom module may include upper and lower cylinders configured to connect a rearmost boom segment of the multi-stage boom to the rotating frame to adjust a vertical angle of the multi-stage boom.

The upper cylinder may connect an upper portion of the rearmost boom segment of the multi-stage boom to a distal end of the rotating frame with an intervention of an “X”-shaped first bracket installed on the upper portion of the rearmost boom,

The lower cylinder may connect a lower portion of the rearmost boom segment to a middle portion of the rotating frame with an intervention of an “X”-shaped second bracket installed on the lower portion of the rearmost boom,

The first and second brackets may be positioned to be close to upper and lower ends of the rearmost boom segment, respectively, so as to suppress torsional and bending deformation of the rearmost boom segment.

According to the present disclosure, the bucket, which has a trapezoidal box shape, is physically robust and exhibits improved resistance to a torsion compared to a conventional rectangular box-shaped bucket. That is, the bucket according to the present disclosure has a trapezoidal bottom surface, which enables to reduce a distance between opposing parallel sides compared to the conventional rectangular box-shaped bucket and results in asymmetrical areas of the opposing parallel sides, thereby exhibiting a strong resistance to a torsional stress.

Since the multi-stage boom of the aerial work assembly is installed obliquely on a horizontal plane on the stage and the bucket is installed on a relatively wide space of the stage when seen from the multi-stage boom 70 positioned obliquely, the aerial work assembly may be installed stably while satisfying design constraints that may be critical because of the stage of limited dimensions.

In addition, since the multi-stage boom is installed obliquely on the stage, a multi-stage boom of a longer length may be installed than a case where the multi-stage boom is installed along the center line of the vehicle parallel to the longitudinal direction of the vehicle.

The bucket is installed on the lateral surface of the foremost boom segment such that the bucket is positioned in the relatively wide space of the stage when seen from the multi-stage boom. Accordingly, it is possible to install the multi-stage boom and the bucket on the stage taking into account a weight balance and minimize a protrusion of the bucket beyond the stage. In addition, since the bucket has a box shape with a trapezoidal cross section and is installed such that a surface with a relatively wider area of the two parallel surfaces may face one lateral surface of the foremost boom segment, the bucket may be maintained stably at the foremost boom segment.

The gathering of the distal ends of the boom segments at which the rollers are installed may reduce a protruding length of the distal ends of the nested boom segments where the rollers are installed from the multi-stage boom compared to a conventional configuration where each roller-equipped boom segment at which existing rollers are installed protrudes cumulatively. The reduction in the protrusion allows to design each boom segment to be longer than the conventional boom segment and enables to increase a reach of the multi-stage boom than the existing multi-stage boom.

Since the rollers of the boom segments are protected from an external environment by the nested roller cases, a risk of a contamination, malfunction, damage to the rollers caused by an exposure to the external environment may be reduced.

Since each of the boom segments has a polygonal prism structure with a polygonal cross-section of more than six sides. the boom segments may provide a superior mechanical durability against stresses such as torsion and bending.

Since the brackets for connecting the upper and lower cylinders adjusting of a vertical angle of the multi-stage boom are installed in the “X”-shaped configuration on upper and lower surfaces of the rearmost boom segment, respectively, the upper and lower cylinders may be firmly connected to upper and lower parts of a base boom of the multi-stage boom. As a result, the “X”-shaped brackets may provide a superior mechanical durability against stresses such as the torsion and the bending when the multi-stage boom is raised and lowered by the upper and lower cylinders.

### BRIEF DESCRIPTION OF THE DRAWINGS

FIG. 1 is a perspective view of an aerial work vehicle according to an exemplary embodiment of the present disclosure.

FIG. 2 is a perspective view of the aerial work vehicle in a state where a multi-stage boom shown in FIG. 1 is expanded.

FIG. 3 is a plan view of the aerial work vehicle of FIG. 1.

FIG. 4 is a lateral view of the aerial work vehicle of FIG. 1.

FIG. 5 is a perspective view of a bucket shown in FIG. 1.

FIG. 6 is a perspective view of a rotating frame shown in FIG. 1.

FIG. 7 is a cross-sectional view taken along a line 7-7 shown in FIG. 6.

FIG. 8 is a perspective view of a lower portion of a multi-stage boom shown in FIG. 1.

FIG. 9 is a perspective view of a front end of the multi-stage boom shown in FIG. 1.

FIG. 10 is a perspective view of the multi-stage boom of FIG. 9 in a retracted state.

FIG. 11 is a perspective view of the multi-stage boom of FIG. 9 in an expanded state.

### DETAILED DESCRIPTION

An aerial work vehicle may include a vehicle equipped with a stage and an aerial work assembly installed on the stage. The aerial work assembly may include a bucket in which a worker can board and a boom module that moves the bucket in a three-dimensional space to a work area. The boom module may include a telescopic multi-stage boom.

In a typical aerial work vehicle, the multi-stage boom is installed along a center line of the vehicle in a longitudinal direction of the vehicle, and the bucket is installed at a distal end of an uppermost boom segment of the multi-stage boom.

A scale of the aerial work assembly that may be installed on the stage may be determined according to a loading capacity of the vehicle. Furthermore, there may be additional design constraints on the aerial work vehicle since the aerial work assembly must be installed on the stage with limited dimensions.

In particular, the aerial work vehicle with a small loading capacity, such as a 1-ton vehicle, has several problems caused by a narrow the stage space such as a weak physical strength of the bucket, protruding of the bucket out of the stage, an imbalance that may arise depending on an installation location of the bucket, and a restriction on a length of the multi-stage boom.

Specifically, the bucket, being an open-topped rectangular box, lacks sufficient physical strength and is vulnerable to twisting or torsion.

Typically, the multi-stage boom is installed on the stage along the center line of the vehicle parallel to the longitudinal direction of the vehicle, and the bucket is installed on the foremost boom of the multi-stage boom. However, if the bucket is installed at the distal end of the foremost boom as such, the bucket may protrude out of the stage in the longitudinal direction of the vehicle. Since there is a constraint on a protruding length of the bucket installed at the distal end of a retracted multi-stage boom and protruding out of the stage, the length of the retracted multi-stage boom must be designed to be shorter according to the length of the bucket.

In case that the bucket is installed on one side of the foremost boom segment to solve the above problem, a center of gravity of the aerial work assembly becomes biased to the side where the bucket is disposed. In such a case, there is an increased risk of safety accidents caused by a weight imbalance during the operation of the aerial work vehicle.

On the other hand, since the multi-stage boom is driven by a telescopic mechanism using wires, a roller is installed on one side of the distal end of each boom segment to hang and guide the wire. In this case, the distal ends of retracted boom segments with aggregated rollers may be protruded beyond the front end of the multi-stage boom. Therefore, when installing the aerial work assembly on the stage, shorter boom segments must be used taking into account the protrusion caused by the rollers in order to satisfy the constraint on the length protruding beyond the stage while connecting the bucket to the multi-stage boom. This causes a loss of a length of the expanded multi-stage boom and reduces a maximum working height that may be reached by the multi-stage boom.

Moreover, the cross-sections of the boom segments comprising the multi-stage boom are typically rectangular or circular, which makes the multi-stage boom structurally vulnerable to mechanical stresses such as torsion or bending.

In the following description and the accompanied drawings, only parts necessary for understanding embodiments of the present disclosure will be described, and detailed descriptions of well-known functions or configuration that may obscure the subject matter of the present disclosure will be omitted for simplicity.

The terms and words used in the following description and appended claims are not necessarily to be construed in an ordinary sense or a dictionary meaning, and may be appropriately defined herein to be used as terms for describing the present disclosure in the best way possible. Such terms and words should be construed as meaning and concept consistent with the technical idea of the present disclosure. The embodiments described in this specification and the configurations shown in the drawings are merely preferred embodiments of the present disclosure are not intended to limit the technical idea of the present disclosure. Therefore, it should be understood that there may exist various equivalents and modifications which may substitute the exemplary embodiments at the time of filing of the present application.

Hereinbelow, exemplary embodiments of the present disclosure will be described in detail with reference to the accompanied drawings.

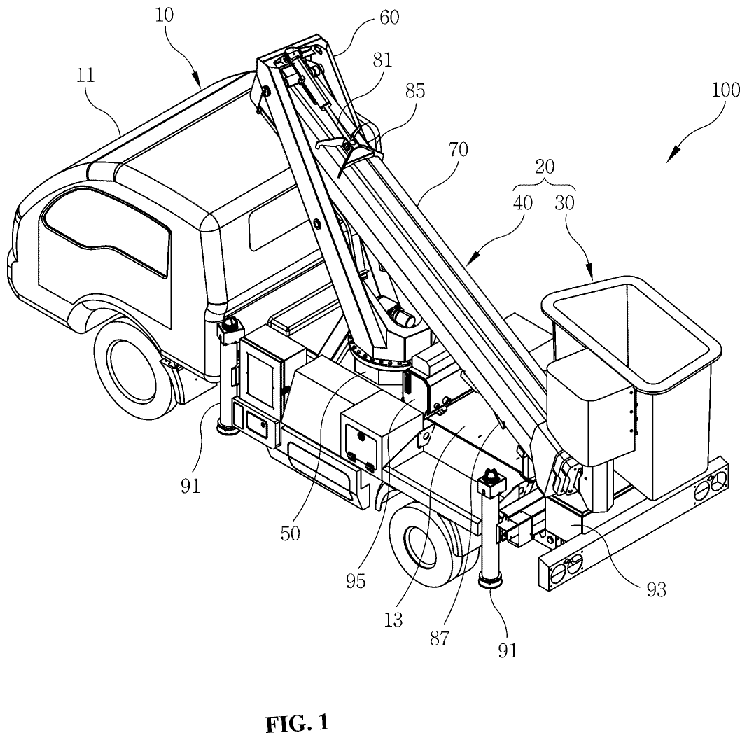

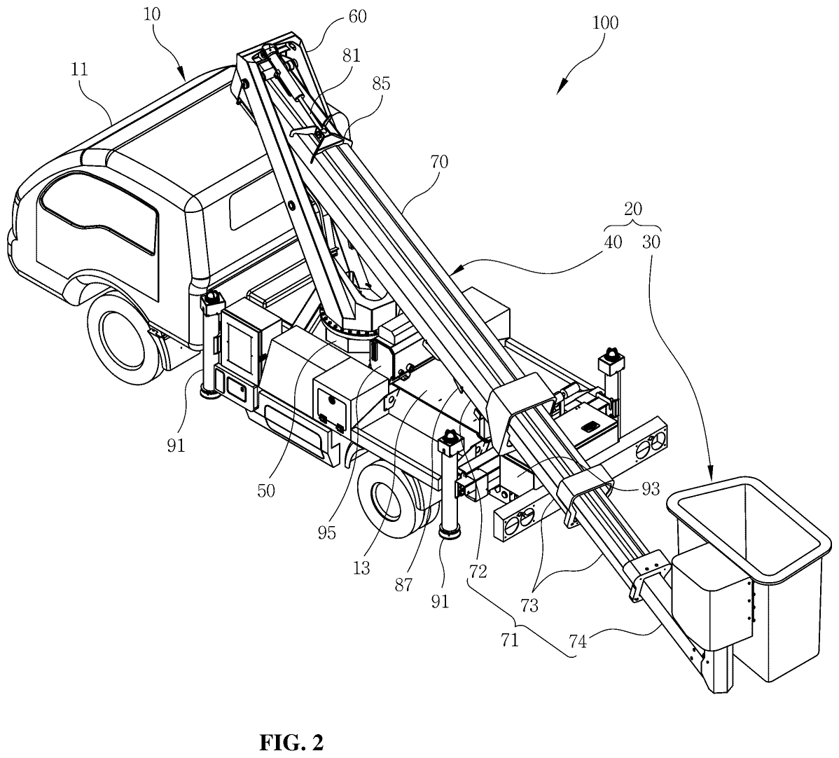

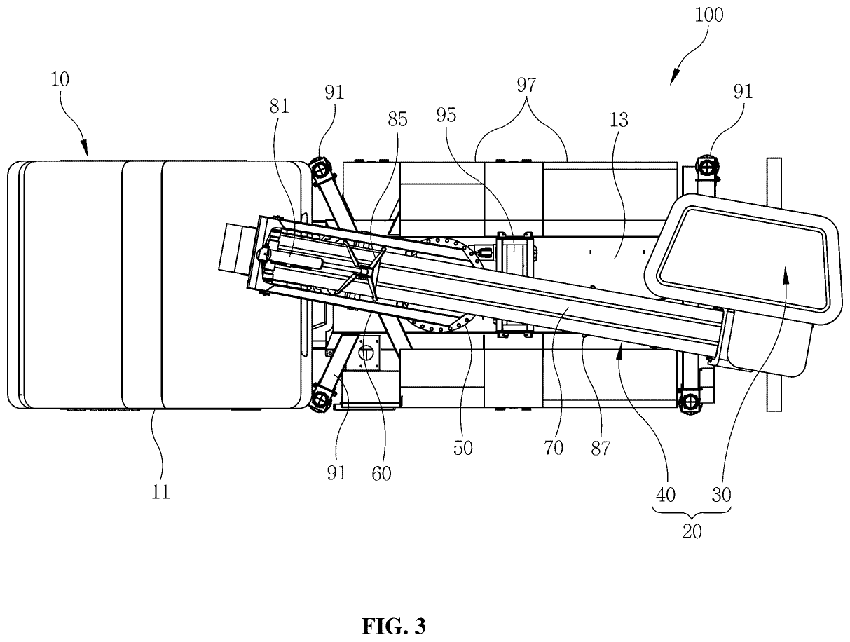

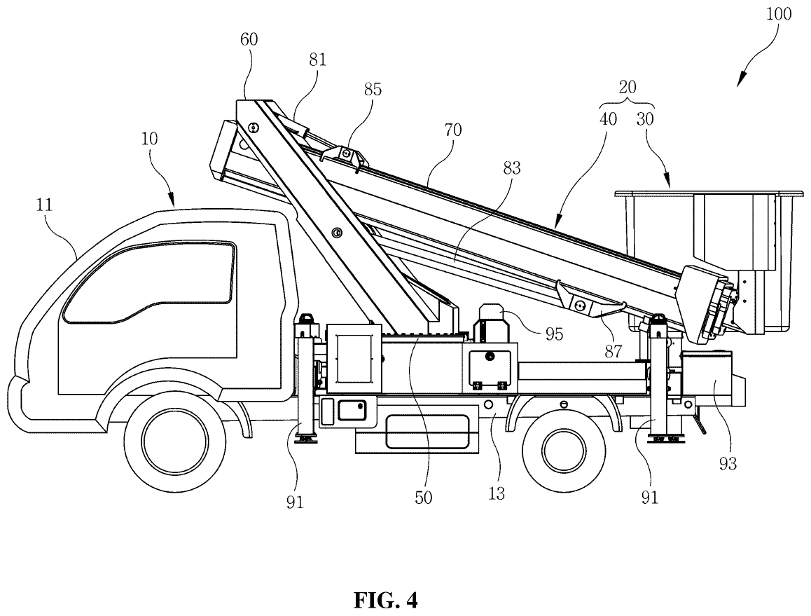

FIG. 1 is a perspective view of an aerial work vehicle according to an exemplary embodiment of the present disclosure. FIG. 2 is a perspective view of the aerial work vehicle in a state where a multi-stage boom shown in FIG. 1 is expanded. FIG. 3 is a plan view of the aerial work vehicle of FIG. 1. FIG. 4 is a lateral view of the aerial work vehicle of FIG. 1.

Referring to FIGS. 1-4, an aerial work vehicle 100 according to the present embodiment may include a vehicle 10 having a stage 13, and an aerial work assembly 20 installed on the stage 13. Here, the aerial work assembly 20 may include a bucket 30 in which a worker can board, and a boom module 40 that moves the bucket 30 in a three-dimensional space to a work area. The boom module 40 may include a multi-stage boom 70 having an end at which the bucket 30 is installed and capable of being expanded and retracted with respect to another end to move the bucket 30 in the three-dimensional space to the work area. In a state that the multi-stage boom 70 is retracted and parked on the stage 13, the boom module 40 may be positioned obliquely with respect to a center line of the vehicle 10 that is parallel to a longitudinal direction of the vehicle 10.

In addition, the aerial work vehicle 100 according to the present embodiment may include at least one of one or more outriggers 91, a battery pack 93, a hydraulic tank 95, and a control box 97, but the present disclosure is not limited thereto.

The aerial work vehicle 100 according to present embodiment will now be described in more detail with reference to FIGS. 1-11.

The vehicle 10 is a transport device for the aerial work vehicle 100. The vehicle 10 may be a combustion engine vehicle, an electric vehicle, or a hybrid electric vehicle, for example. The vehicle 10 may include a vehicle body 11 and the stage 13 located behind the vehicle body 11. The vehicle body 11 may include a driver's cabin and additional components necessary for driving the vehicle 10. The stage 13 may provide a space for mounting the aerial work assembly 20. The stage 13 may be a loading space of the vehicle 10, a chassis or frame on which the vehicle body 11 is mounted.

The outriggers 91 may support the vehicle 10 when the aerial work assembly 20 is in operation. These outriggers 91 may be installed on the stage 13 side. In detail, the outriggers 91 may be installed on left and right sides at front and rear ends of the stage 13 to be expandable and retractable so as to stably support the vehicle 10 and thereby support the aerial work vehicle 100 on the ground.

The battery pack 93 supplies electrical energy required for the operation of the aerial work vehicle 100. The battery pack 93 may be based on a lead-acid battery or a secondary battery. In case where the vehicle 10 is an electric vehicle or a hybrid electric vehicle, the battery pack 93 may be based on a secondary battery.

The hydraulic tank 95 may be installed on the stage 13 to supply hydraulic pressure required for driving upper and lower cylinders 81 and 83 for expanding or retracting the multi-stage boom 70.

The control box 97 allows an operator to control the operation of the aerial work vehicle 100. The control box 97 is equipped with one or more valves, one or more levers, one or more buttons, and/or one or more joysticks for manipulating the aerial work assembly 20 and/or the outriggers 91. The control box 97 may be equipped with a display device such as a light emitting diode (LED) with a touch screen allowing the operator to check an operation status of the aerial work assembly 20 and/or the outriggers 91. In case where the LED with a touch screen is provided as a display device, the touch screen may function as an input device, and the input devices such as the valve, the levers, the buttons, and/or the joysticks may be omitted.

The aerial work assembly 20 may include the bucket 30 and the boom module 40 as mentioned above.

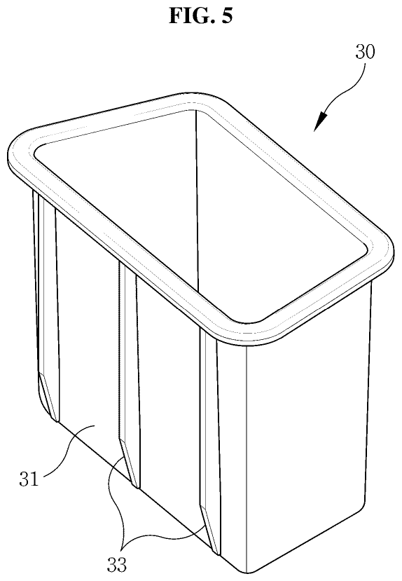

FIG. 5 is a perspective view of the bucket 30 shown in FIG. 1. Referring to FIG. 5, the bucket 30 has a box shape with a trapezoidal cross section.

The reason why the bucket 30 is implemented in a trapezoidal box shape is that the shape is physically robust and exhibits improved resistance to a torsion compared to a conventional rectangular box-shaped bucket. That is, the bucket 30 according to the present embodiment has a trapezoidal bottom surface, which enables to reduce a distance between opposing parallel sides compared to the conventional rectangular box-shaped bucket and results in asymmetrical areas of the opposing parallel sides, thereby exhibiting a strong resistance to a torsional stress.

Such a bucket 30 may be made of an insulating material to ensure a safe operation of the worker during a live-line work. The edges of the bucket 30 may be formed with rounded corners rather than sharp angles so as to suppress sparks that may be caused by a current leakage during the live-line work. To reinforce the structural strength of the bucket 30, the bucket 30 may have a plurality of reinforcement bars 33 formed on its exterior surface and arranged in a vertical direction. As a result, the bucket 30 may include a bucket body 31 having the box shape with the trapezoidal cross section and a plurality of reinforcement bars 33 formed in the vertical direction on at least one of outer surfaces of the bucket body 31.

The boom module 40 may include a drive table 50, a rotating frame 60, and the multi-stage boom 70. The drive table 50 may be installed on the stage 13 and can rotate horizontally. The rotating frame 60 may be installed on the drive table 50 and have a shape of a polygonal prism with an internal hollow 62A. The multi-stage boom 70 may be coupled to the rotating frame 60.

In addition, the boom module 40 may further include the upper and lower cylinders 81 and 83.

As shown in FIG. 3, the drive table 50 may be installed on the stage 13 such that its center is located on the center line of the vehicle 10 that is parallel to the longitudinal direction of the vehicle 10. The drive table 50 rotates clockwise or counterclockwise according to a rotational power received from a motor. This drive table 50 may have a circular disk shape.

The rotating frame 60 may be installed on the drive table 50. The rotating frame 60 may be installed to have a certain incline angle to be leaned with respect to the drive table 50. As a result, when the rotating frame 60 rotates on the drive table 50, the rotating frame 60 may create a conical trajectory when viewed from the side or rear of the vehicle 10. Various devices installed on the vehicle body 11 and the stage 13 may be disposed below the rotational trajectory of the rotating frame 60 and the multi-stage boom 70.

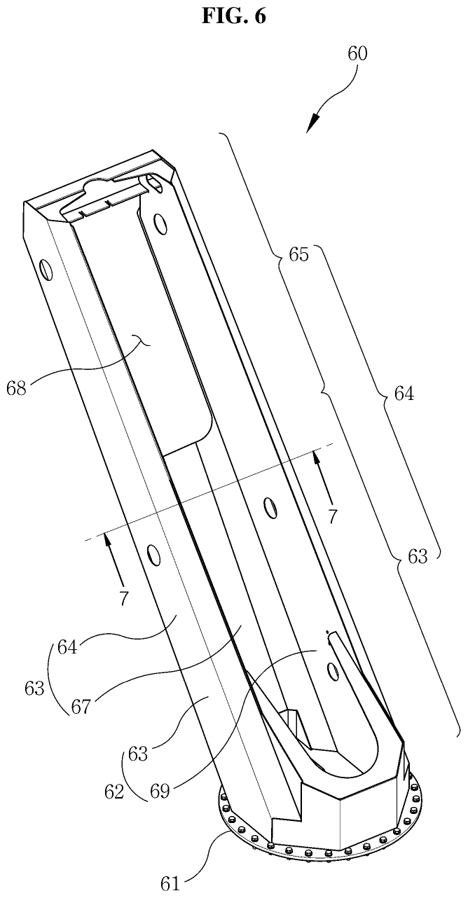

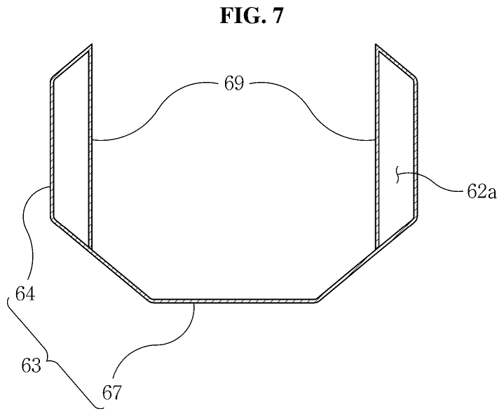

The rotating frame 60 may be implemented by a polygonal prism structure having the internal hollow 62A as shown in FIGS. 6 and 7. Here, FIG. 6 is a perspective view of the rotating frame 60 shown in FIG. 1, and FIG. 7 is a cross-sectional view taken along a line 7-7 shown in FIG. 6.

In other words, the rotating frame 60 may have a tubular shape with one side open. The multi-stage boom 70 may be installed in the open portion of the rotating frame 60 with an intervention of the upper and lower cylinders 81 and 83. That is, the rotating frame 60 may be a tubular member having a “U”-shaped polygonal cross-section. The open part of the rotating frame 60 may be formed along the longitudinal direction of the rotating frame 60.

The internal hollow 62A formed in the rotating frame 60 contributes to a reduction in an overall weight of the rotating frame 60. In addition, since the rotating frame 60 may be formed by bending a metal plate into the polygonal prism structure, the rotating frame 60 may exhibit a superior mechanical durability against stresses such as torsion and bending.

The rotating frame 60 may include a support plate 61 coupled to the drive table 50 and a frame shaft 62 coupled to the support plate 61. The frame shaft 62 may include a base shaft 63 having a “U”-shaped polygonal cross-section and shaft wall plates 69 attached to the opposing inner surfaces of the base shaft 63 to form inner walls of the internal hollow 62A.

The base shaft 63 may include a pair of shaft plates 64 facing each other and a connecting plate 67 connecting the pair of shaft plates 64. Each of the shaft wall plates 69 may be attached to respective one of the inner surfaces of the shaft plates 64 to form the inner walls of the hollow portion 62A. The shaft plate 64 and the connecting plate 67 may be integrally formed by bending a single metal plate.

To allow one end of the multi-stage boom 70 connected to an upper portion of the rotating frame 60 to be tilted with respect to the rotating frame 60 while being expanded or retracted, a portion of the connecting plate 67 is removed at an upper end of the base shaft 63 so as to form an opening 68. As a result, upper portions of the shaft plates 64 are not directly connected to the connecting plate 67. These upper portions of the shaft plates 64 may be referred to as separated plates 65 and the remaining lower portions of the shaft plates 64 may be referred to as integral plates 66. Upper ends of the separated plates 65 may be connected to each other.

The upper and lower cylinders 81 and 83 connect a rearmost boom segment 72 of the multi-stage boom 70 to the rotating frame 60 and allow an adjustment of a vertical angle of the multi-stage boom 70. The upper cylinder 81 connects an upper portion of the rearmost boom segment 72 of the multi-stage boom 70 to a front end of the rotating frame 60. Here, the upper cylinder 81 and the rearmost boom segment 72 may be connected with an intervention of an “X”-shaped first bracket 85 installed on the upper portion of the rearmost boom 72. The lower cylinder 83 connects a lower portion of the rearmost boom segment 72 to a middle portion of the rotating frame 60. Here, the lower cylinder 83 and the rearmost boom segment 72 may be connected with an intervention of an “X”-shaped second bracket 87 installed on the lower portion of the rearmost boom 72.

Each of the upper and lower cylinders 81 and 83 may be a hydraulic cylinder and may include a cylinder body and a cylinder rod. The cylinder body of the upper cylinder 81 may be rotatably mounted on a pair of separated plates 65 and the cylinder rod of the upper cylinder 81 may be connected to the first bracket 85. The cylinder body of the lower cylinder 83 may be rotatably mounted on a pair of integral plates 66 and the cylinder rod the lower cylinder 83 may be connected to the second bracket 87.

Since the first and second brackets 85 and 87 are positioned to be close to upper and lower ends of the rearmost boom segment 72, respectively, and installed in the “X”-shaped configuration on upper and lower surfaces of the rearmost boom segment 72, respectively, the first and second brackets 85 and 87 may suppress torsional and bending deformation of the rearmost boom segment 72 that may occur when the multi-stage boom 70 is expanded or retracted by the operation of the upper and lower cylinders 81 and 83 or when the rotating frame 60 is rotated.

Since the multi-stage boom 70 connected to the rotating frame 60 may pivot vertically about a proximal end of the rearmost boom segment 72, the lower cylinder 83 connected to a distal end of the rearmost boom segment 72 is longer than the upper cylinder 81 connected to the proximal end of the rearmost boom segment 72. Meanwhile, since the lower cylinder 83 provides most of the lifting force needed to raise the multi-stage boom 70, the lower cylinder 83 has a larger capacity than the upper cylinder 81. The upper cylinder 81 serves a supplementary role, stabilizing the vertical movement of the multi-stage boom 70 when the multi-stage boom 70 is raised or lowered by the lower cylinder 83.

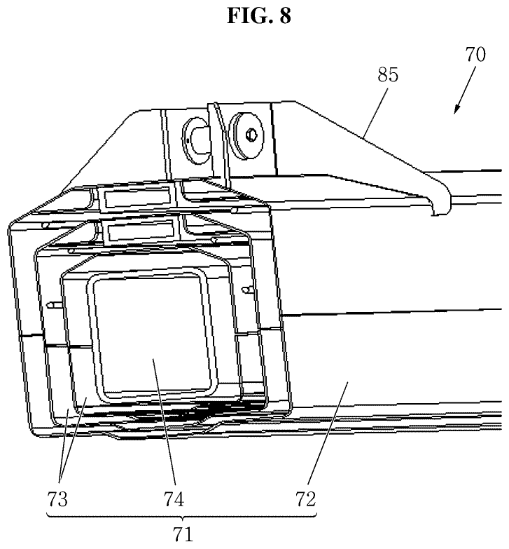

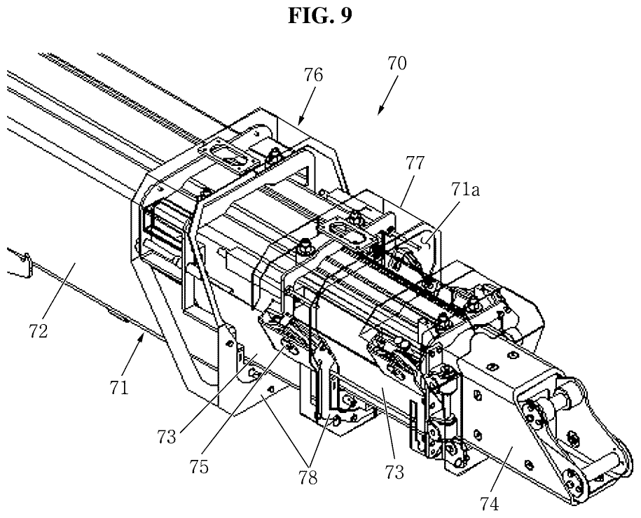

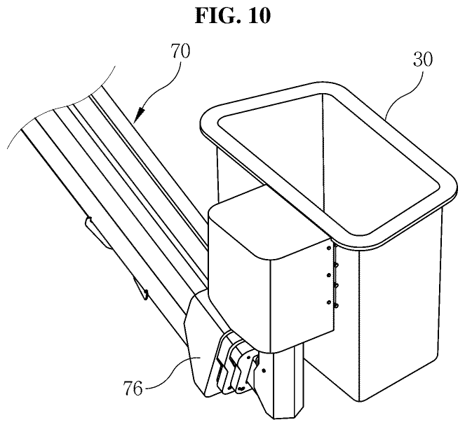

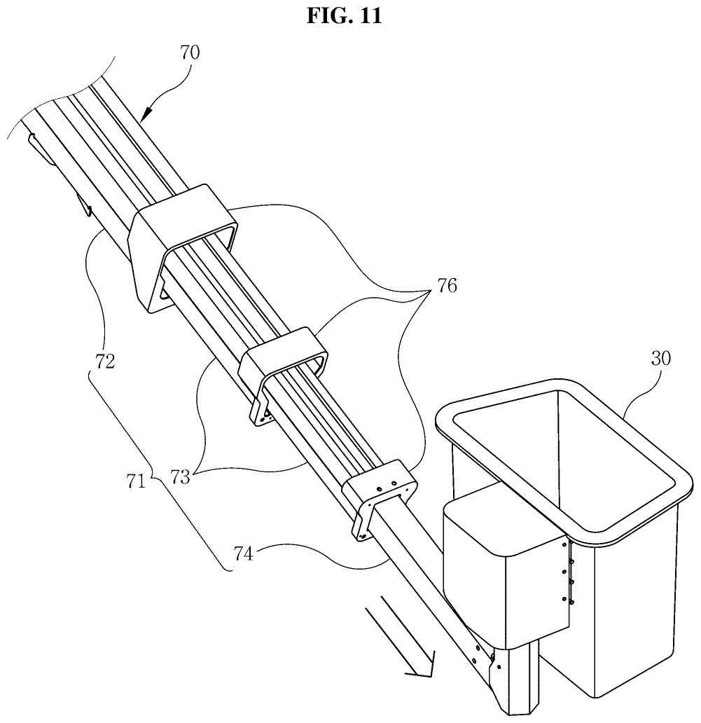

As shown in FIGS. 8-11, the multi-stage boom 70 may include a plurality of boom segments 71 that are expandable and retractable telescopically by rollers 75 and wires. Here, FIG. 8 is a perspective view of the lower portion of the multi-stage boom 70 shown in FIG. 1. FIG. 9 is a perspective view of the front end of the multi-stage boom 70 shown in FIG. 1. FIG. 10 is a perspective view of the multi-stage boom 70 of FIG. 9 in a retracted state. FIG. 11 is a perspective view of the multi-stage boom 70 of FIG. 9 in an expanded state.

The multi-stage boom 70 may include the rearmost boom segment 72 connected to the rotating frame 60, one or more intermediate boom segments 73 sequentially inserted into the rearmost boom segment 72, and a foremost boom segment 74 positioned inside the intermediate boom segments 73. The rearmost boom segment 72 is the outermost boom segment of the multi-stage boom 70. The multi-stage boom 70 according to the present embodiment may include two intermediate boom segments 73, for example.

When the multi-stage boom 70 is expanded, the intermediate boom segments 73 and the foremost boom segment 74 may be expanded by a same length with respect to the rearmost boom segment 72.

The rearmost boom segment 72 may be unexpandable since the rearmost boom segment 72 is installed on the rotating frame 60 with the intervention of the upper and lower cylinders 81 and 83. The intermediate boom segments 73 and the foremost boom segment 74 may be sequentially inserted into the rearmost boom segment 72 in a nested manner.

The proximal end of the rearmost boom segment 72 may be coupled to the upper end between the pair of shaft plates 64 via an upper cylinder 81. In other words, the rearmost boom segment 72 may be disposed such that the proximal end of the rearmost boom segment 72 is inserted into the opening 68 between the pair of separated plates 65, and the pair of separated plates 65 and the upper surface of the proximal end portion of the rearmost boom segment 72 may be coupled to the upper cylinder 81. The integral plate 66 and the lower surface of the distal end portion of the rearmost boom segment 72 may be coupled to the lower cylinder 83.

When the multi-stage boom 70 is in the retracted state and positioned on the stage 13, the multi-stage boom 70 may be positioned obliquely to be inclined downward such that the proximal end of the rearmost boom segment 72 is positioned higher than the distal end. At this time, the cylinder rod of the upper cylinder 81 may be in an expanded state, and the cylinder rod of the lower cylinder 83 may be in a retracted state. The bucket 30 is installed on the foremost boom segment 74 located near the distal end of the rearmost boom segment 72.

The expansion and retraction of the upper and lower cylinders 81 and 83 are performed in opposite directions. That is, in a state where the multi-stage boom 70 is in the retracted state and positioned obliquely, retracting of the upper cylinder 81 and expanding of the lower cylinder 83 causes the front end of the multi-stage boom 70 to move upward. Conversely, expanding of the upper cylinder 81 and retracting of the lower cylinder 83 causes the front end of the multi-stage boom 70 to move downward.

The bucket 30 may be installed on a lateral surface of the foremost boom segment 74. This lateral surface of the foremost boom segment 74 corresponds to a surface that faces a relatively wider space of the stage 13 in a viewpoint from the multi-stage boom 70 positioned obliquely when the multi-stage boom 70 is retracted and parked on the stage 13.

If the bucket 30 is installed on the lateral surface of the foremost boom segment 74 such that the bucket 30 is positioned in the relatively wide space of the stage 13 when seen from the multi-stage boom 70 as described above, it is possible to minimize a weight imbalance caused by the oblique positioning of the multi-stage boom 70 with respect to the center line of the vehicle 10 parallel to the longitudinal direction of the vehicle 10 while minimizing a protrusion of the bucket 30 beyond the stage 13 also.

As described above, the bucket 30 has a box shape with a trapezoidal cross section. Since the bucket 30 is installed such that a surface based on a longer edge of two parallel edges of the trapezoid may face one lateral surface of the foremost boom segment 74, the bucket 30 may be maintained stably at the foremost boom segment 74.

Each boom segment 71 has a tubular structure with a polygonal cross-section of more than six sides. Accordingly, the boom segments 71 may exhibit a superior mechanical durability against stresses such as torsion and bending which may occur during expansion, retraction, or rotation of the boom segments. According to the present embodiment, the boom segments 71 except for the foremost boom segment 74 may have a tubular shape with a decagonal cross-section, for example. Specifically, each of the boom segments 71 may generally have a tubular shape with four faces—top, bottom, and two lateral faces—where each of the top and bottom faces may be formed as multi-faceted surfaces with three or more facets. The upper and lower faces of the boom segments may be formed with an outward convex shape.

Since the foremost boom segment 74 is located at the innermost position in the multi-stage boom 70, the foremost boom segment 74 is protected by the other boom segments 71 surrounding the foremost boom segment 74 and is relatively less affected by the mechanical stresses such as the torsion or bending than the other boom segments 71. Taking into account such an installation condition, the foremost boom segment 74 may have a tubular shape with a rectangular cross-section.

For the aerial work vehicle 100 according to the present embodiment for use in a live-line operation, the foremost boom segment 74 may be implemented by a boom segment 71 made of an insulating material.

In a state where the multi-stage boom 70 is retracted with the plurality of boom segments 71 nested, rollers 75 installed at distal ends of the plurality of boom segments 71 are gathered at a location. The gathering of the distal ends of the boom segments 71 at which the rollers 75 are installed may reduce a protruding length of the distal ends of the nested boom segments 71 where the rollers 75 are installed from the multi-stage boom 70 compared to a conventional configuration where each roller-equipped boom segment 71 at which existing rollers 75 are installed protrudes cumulatively. The reduction in the protrusion allows to design each boom segment 71 to be longer than the conventional boom segment and enables to increase a reach of the multi-stage boom 70 than the existing multi-stage boom.

Each boom segment 71 on which the roller 75 is installed is provided with a roller case 76 mounted at the distal end of the boom segment 71 to protect the roller 75. The roller cases 76 of the boom segments 71 preceding the rearmost boom segment 72 are sequentially inserted and nested in the roller case 76 of the rearmost boom segment 72. A stopper 78 may be provided at an entrance opening 71A at the distal end of each boom segment 71 capable of being inserted to another boom segment to ensure stable insertion and nesting of the roller cases 76 when the preceding roller cases 76 are sequentially inserted and nested in the rearmost roller case 76. The stopper 78 may be provided at the roller case 76 of the boom segment 71 being inserted to another boom segment. During the retraction and nesting of the boom segments, the stopper 78 of a preceding boom segment 71 being inserted may be caught and fixed by the stopper 78 of another boom segment 71 receiving preceding boom segment.

The roller case 76 may include a roller accommodating portion 77 suitable for receiving the roller 75 and the stopper 78 coupled to the roller accommodating portion 77. The stopper 78 may be located closer to the entrance opening 71A of the boom segment 71 than the roller accommodating portion 77. When the boom segments 71 are being retracted and nested, the roller accommodating portions 77 of the roller cases 76 are nested and the stoppers 78 are sequentially stacked and protrude outward.

In addition, since the rollers 75 of the boom segments 71 are protected from the external environment by the nested roller cases 76, a risk of a contamination, malfunction, damage to the rollers 75 caused by an exposure to the external environment may be reduced.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An aerial work assembly for use in an aerial work vehicle installed on a stage of the aerial work vehicle, comprising:
a bucket in which an operator can board; and
a boom module comprising a multi-stage boom having an end at which the bucket is installed and configured to be expanded and retracted to move the bucket in a three-dimensional space to a work area,
wherein the multi-stage boom comprises a plurality of boom segments expandable and retractable telescopically by rollers and wires,
wherein, in response to the multi-stage boom being retracted with the plurality of boom segments nested, the rollers installed at distal ends of the plurality of boom segments are configured to be gathered at a location,
wherein each of the plurality of boom segments on which the rollers are installed comprises a roller case mounted at the distal end of the boom segment to protect the roller, and
wherein roller cases of boom segments preceding a rearmost roller case are configured to be sequentially inserted and nested in the rearmost roller case.

2. The aerial work assembly as claimed in claim 1, wherein, in response to the multi-stage boom being retracted and parked on the stage, the boom module is configured to be positioned obliquely with respect to a center line of the vehicle parallel to a longitudinal direction of the vehicle.

3. The aerial work assembly as claimed in claim 2, wherein the boom module comprises:
a drive table installed on the stage and capable of rotating horizontally;
a rotating frame installed on the drive table and having a polygonal prism shape with an internal hollow; and
the multi-stage boom coupled to the rotating frame.

4. The aerial work assembly as claimed in claim 2, wherein the bucket is installed on a lateral surface of a foremost boom segment of the multi-stage boom, and
wherein the lateral surface corresponds to a surface facing a relatively wider space of the stage in a viewpoint from the multi-stage boom positioned obliquely when the multi-stage boom is retracted and parked on the stage.

5. The aerial work assembly as claimed in claim 4, wherein the bucket has a box shape with a trapezoidal cross section and installed such that a surface based on a longer edge of two parallel edges of a trapezoid may face the lateral surface of the foremost boom segment.

6. The aerial work assembly as claimed in claim 5, wherein the foremost boom segment and the bucket are made of an insulating material.

7. The aerial work assembly as claimed in claim 1, wherein the roller case comprises:
a roller accommodating portion configured to receive the roller; and
a stopper coupled to the roller accommodating portion,
wherein the stopper is located closer to an entrance opening of a corresponding boom segment than the roller accommodating portion,
wherein, in response to the boom segments being retracted and nested, the roller accommodating portions of the roller cases are nested and the stoppers are sequentially stacked and protrude outward.

8. The aerial work assembly as claimed in claim 1, wherein each of the boom segments has a tubular structure with a polygonal cross-section of more than six sides.

9. The aerial work assembly as claimed in claim 3, wherein the boom module further comprises:
upper and lower cylinders configured to connect a rearmost boom segment of the multi-stage boom to the rotating frame to adjust a vertical angle of the multi-stage boom,
wherein the upper cylinder connects an upper portion of the rearmost boom segment of the multi-stage boom to a front end of the rotating frame with an intervention of an “X”-shaped first bracket installed on the upper portion of the rearmost boom,
wherein the lower cylinder connects a lower portion of the rearmost boom segment to a middle portion of the rotating frame with an intervention of an “X”-shaped second bracket installed on the lower portion of the rearmost boom,
wherein the first and second brackets are positioned to be close to distal and proximal ends of the rearmost boom segment, respectively, so as to suppress torsional and bending deformation of the rearmost boom segment.

10. An aerial work vehicle comprising:
a vehicle comprising a stage; and
an aerial work assembly installed on the stage,
wherein the aerial work assembly comprises:
a bucket in which an operator can board; and
a boom module comprising a multi-stage boom having an end at which the bucket is installed and capable of being expanded and retracted to move the bucket in a three-dimensional space to a work area,
wherein the multi-stage boom comprises a plurality of boom segments expandable and retractable telescopically by rollers and wires,
wherein, in response to the multi-stage boom being retracted with the plurality of boom segments nested, the rollers installed at distal ends of the plurality of boom segments are configured to be gathered at a location,
wherein each of the plurality of boom segments on which the rollers are installed is provided with a roller case mounted at the distal end of the boom segment to protect the roller, and
wherein roller cases of boom segments preceding a rearmost roller case are sequentially inserted and nested in the rearmost roller case.
